(19) United States
(12) Patent Application Publication
(10) Pub. No.: US 2002/0143705 A1
(43) Pub. Date: Oct. 3, 2002

(54) Business model for content and software providers

(75) Inventor: Peter Bernhard Kaars, Cupertino, CA (US)

Correspondence Address: Corporate Patent Counsel, Philips Electronics North America Corporation, 580 White Plains Road, Tarrytown, NY, 10591, US

(73) Assignee: KONINKLIJKE PHILIPS ELECTRONICS N.V.

(21) Appl. No.: 09/821,965

(22) Filed: Mar. 30, 2001

Related U.S. Application Data
(60) Provisional application No. 60/221,400, filed on Jul. 28, 2000.

(51) Int. Cl. H04K 1/00; H04L 9/00; G06F 17/60

(52) U.S. Cl. 705/51

(57) ABSTRACT

A business model is provided for the delivery of complete service to users. A content provider and a software provider cooperate to deliver a content information and the proper software element that would enable to play-out or render the content information. A request from a user for the content information advertised by the content provider selectively triggers a request for the software element. The content provider financially compensates the software provider for the transfer of the software element.

### FIELD OF THE INVENTION

The invention relates to a method of being compensated for a transfer of a software element to render a content information. The invention also relates to a method of providing the content information. The invention relates to a business model between a content provider and a software provider, both cooperating to provide a data service to a user.

### BACKGROUND ART

Content information may be distributed over an information network such as the Internet where a content distributor advertises the content information that can be transferred to registered users. When downloaded or streamed, a piece of content information often requires the use of a software component to adequately render the content. For example, a flash animation on a Web page can only be played-out if a flash player was previously installed in the browser of the client requesting the Web page. Thus, content providers need to make the proper software element available to users to enable them to play out the content information. As a result, content providers cooperate with software providers to offer efficient and adapted data services to users. Commonly, the content and software providers come to an agreement to propose free download of software elements to users downloading video or audio files from the content provider's Web site.

Content information may also be distributed over an information network as a service from a cable provider to a group of subscribers. Typically, a set top box is a CE appliance that enables the user to receive services from a cable provider to which the user has subscribed. The services relate to the supply of content information and to applications such as email and chat room. The cable provider determines the specification of the set top box as well as the content delivered to the set top box and hardware manufacturers, then, design according to the set top box specifications.

A known business model in the set top box market is, for example, based on the number of subscriptions to the cable provider's service. The hardware manufacturer supplies the set top box, e.g., against manufacturing costs, to the cable provider and receives a part of the cable provider's revenues based on the number of subscribers.

### SUMMARY OF THE INVENTION

This and other business models leave little room for the software provider to influence the growth rate of the number of users and thereafter to get profit from an increase in requests for content information or software elements. In the set top box market, the manufacturer is given few opportunities to cooperate with the cable provider on other levels than of merely original equipment manufacturer (OEM). The inventor now has realized that a business model is possible that is to the benefit of the cable provider, the original manufacturer of the set top box and the end user. At the same time the model creates room for the original manufacturer to cooperate with the cable provider during the operational use of the set top box without creating conflicts of interest with the cable provider.

An object of the invention is to provide a business model that allows a software provider to benefit from the transfer of a software component to be used to render a piece of content information made available by a content provider.

Another object of the invention is to provide a business model establishing a relationship between a distributor of a content information and a provider of a software used to render the content information.

To this end, the first business model of the invention, which relates to being compensated for a transfer of the software element, comprises financially charging a content provider of the content information based on the transfer of the software element being triggered by an individual's request for the content information.

This first business model concerns a party such as a software provider being compensated by a content provider based on a request for a content information of the content provider. The transfer of the software element may be caused by an individual who requests a piece of content information and who does not have the appropriate software to play-out the content information. The transfer may also be triggered when a registered user requests content information of a given format from the content provider for the first time. In such a business model, the content provider and the software provider may work closely together to provide a complete data service to the user. The content provider may provide the content information service and the software provider may be in charge of the provision of the appropriate software and of the maintenance of the transferred software elements, such as making sure that the updates are made available on time. The software provider may be compensated in different manners. A first possible compensation could be a direct monetary fee applied on each transfer of the software element triggered by a request for an information content. Such a compensation may also comprise any advantage, partnership or favorable condition accorded by the content provider to the software provider that ultimately financially benefits the software provider. An advantage of the invention is to allow the software provider to influence a service offered by the content provider. Another advantage of the invention is to allow separating the transfer of the content information controlled by the content provider and the transfer and maintenance of the software element controlled by the software provider.

The second business model of the invention, which relates to providing the content information, first comprises advertising the content information. This second model also comprises causing an individual's request for the content information to selectively trigger a transfer of a software element to render the content information. The model then comprises financially compensating the provider of the software element based on the transfer of the software element.

This second business model concerns the content provider who advertises the content information. The advertising may be done by a cable provider offering to stream various entertainment programs to his subscribers. The advertising may also be done by a content provider offering users to download or stream audio or video files over the Internet from one of his servers or from a storage medium of another user using a peer-to-peer communication model. In this model, a request for a piece of content information may trigger the transfer of the software element. Indeed, the software element is not necessarily transferred to a user who already has the last version of the software element present on his hard-drive or set top box. Similarly, the software is not transferred if log records indicate that the user has downloaded in the past content information of similar audio or video format. In this case, it may be alleged that the software element or an equivalent is already present on the user's hard-drive or set top box.

As to the set top box market, the inventor proposes to enhance the cable provider's infrastructure with a remote maintenance service by taking care of downloading the proper software and/or their upgrades to allow the subscriber to receive and keep on receiving the cable provider's content and using the applications. This frees the cable provider of doing the maintenance himself on an appliance from the OEM or to maintain a call center for support of customers regarding issues related to the set top box. This maintenance is preferably transparent to the end-user. For example, when content information in a new format is being made available for which older set top boxes do not have the proper software, the OEM can provide the upgrade software and have it installed at the set top box via the Internet or another data network. Alternatively, the OEM assumes the liability vis-a-vis the cable provider but delegates to a contract partner the providing and installation of new software and/or upgrades.

Accordingly, the invention relates to a method of enabling the download of decoders or plug-ins, and to a method of making available content information via a data network, and to a method of attributing the download of a decoder or plug-in to the referenced content information. The invention addresses a business model for creating revenues based on supplying software or an upgrade, e.g., a decoder, or plug-in, via the Internet. Another factor is the minimal intervention required from the end-user. When a user selects from the cable provider's services content information of a certain type or format for the first time for downloading or being streamed, the associated decoder or plug-in or their upgrade is downloaded and installed at the user's network decoding appliance, e.g. set top box, computer or Internet phone. Any next selection of content of the same type or format or category by the same end-user skips the downloading of the decoder or plug-in or their upgrade. The supplier of the content, e.g., the cable operator, is charged a fee per download of the decoder or plug-in or their upgrade. It is easy to monitor the number of downloads of the decoder or plug-in or their upgrade that have been induced by an end-user selecting the content information hosted by the content server. The invention enables a business model for supplying software decoders and plug-ins and their upgrades. The availability of new content information together with the user not being charged for the decoder, plug-in or their upgrade, attracts customers and generates traffic via the portal or other web site advertising this service. The download of the decoder or plug-in or their upgrade can be administered for a specific type of encoded content information or encoding format or to a specific piece of content information.

The distribution model can be tailored to certain conditions if the parties involved so wish. For example, the software can be time-stamped so as to make them valid for a certain time period, or they can be provided with a counter so as to have them operational for only a predetermined number of play-outs. An upgrade, in terms of a new time stamp or a counter reset can then be easily achieved via the Internet upon the user requesting a new file or the same file for a new cycle of play-outs. As another example, the software can be remotely enabled or disabled under control of the cable provider or the OEM.

### BRIEF DESCRIPTION OF THE DRAWING

The invention is explained in further detail, by way of example and with reference to the accompanying drawing, wherein:

FIG. 1 illustrates a method of the invention;

FIG. 2 illustrates a method of the invention; and,

FIG. 3 is a block diagram of a system in the invention.

### DETAILED EMBODIMENTS

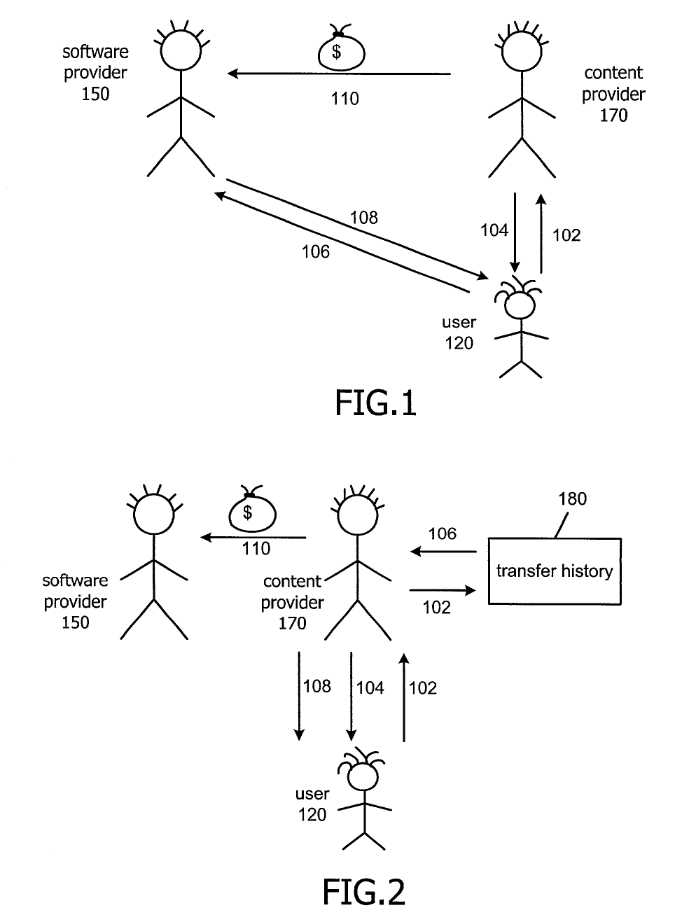

FIG. 1 depicts a software provider 150 and a content provider 170 cooperating to deliver proper software and content information to users according to a method of the invention. In a method of the invention a user 120 transmits a request 102 for a content information to the content provider 170. This request 102 may be caused by the user 120 clicking on a link for an audio or video file advertised by the content provider 170 on his Web site. The request 102 may also be caused by the user 120 selecting a given channel program on the electronic program guide provided by the content provider 170. The request 102 may also be caused by the user 120 asking to retrieve, on his set top box, an email or message from a message server of the content provider. The content information is to be transferred to a memory of a device, such a personal computer, a PDA, a set top box of the user 120. The content information may be either downloaded or streamed during the transfer 104. The content provider 170 has configured his data service to the user so that the request 102 selectively triggers a request 106 for the transfer of a specific software element or any appropriate software element that enables rendering the content information. In this embodiment, the request 106 is triggered by the user 120 himself who notices that he does not have the appropriate software element to render the content information. This may also be done by the content provider 170 referring the software provider 150 to the user 120 when transferring the content information to the user 120. The request 106 may also be caused by the user 120 selecting a link on the Web site of the content provider 170 to download the software element. The link may automatically direct the user 120 to the software provider 150. The software element is then transferred by the software provider 150 to the user 120, as shown by the arrow 108. The content provider 170 then financially compensates the software provider 150 with a compensation 110. This financial compensation 110 may comprise any advantage, advertising, money transfer or partnership that the content provider 170 accords to the software provider 150 and that creates financial value for the software provider 150. The content provider 170 may make the software element available to the user 120 for free or may decide to charge the user 120 for each software element transferred.

FIG. 2 illustrates another embodiment of a business method of to the invention. First, the user 120 requests the transfer for the content information advertised by the content provider 170. The content provider 170 keeps track of data transferred to the user 120 in the past in a transfer history 180. The transfer history 180 may represent a list of content information transferred to the user 120. Alternatively, the transfer history 180 may represent a list of software elements transferred to the user 120. The content provider compares the request 102 for the content information with the transfer history 180 associated with the user 120. If the transfer history 180 does not show the user 120 having a proper software element to render the content information, the request 106 for the software element is issued. For example, the content provider 170 compares the content information with the list of previously transferred content information to check if data of similar format has already been transferred to the user 120. Therefrom the content provider 170 can allege whether the user 120 already has an adequate software element to render the content information. The software element is then transferred as shown by the arrow 108 representing the transfer of the software element. The software element may be transferred together with the content information. In this embodiment, the content provider 170 transfers the software element. The software provider 150 may have delegated the download of the software element to the content provider 170 but the software provider 150 may keep control over the maintenance of the software element. The software provider 170 then receives a financial compensation 110 for the transfer of the software element.

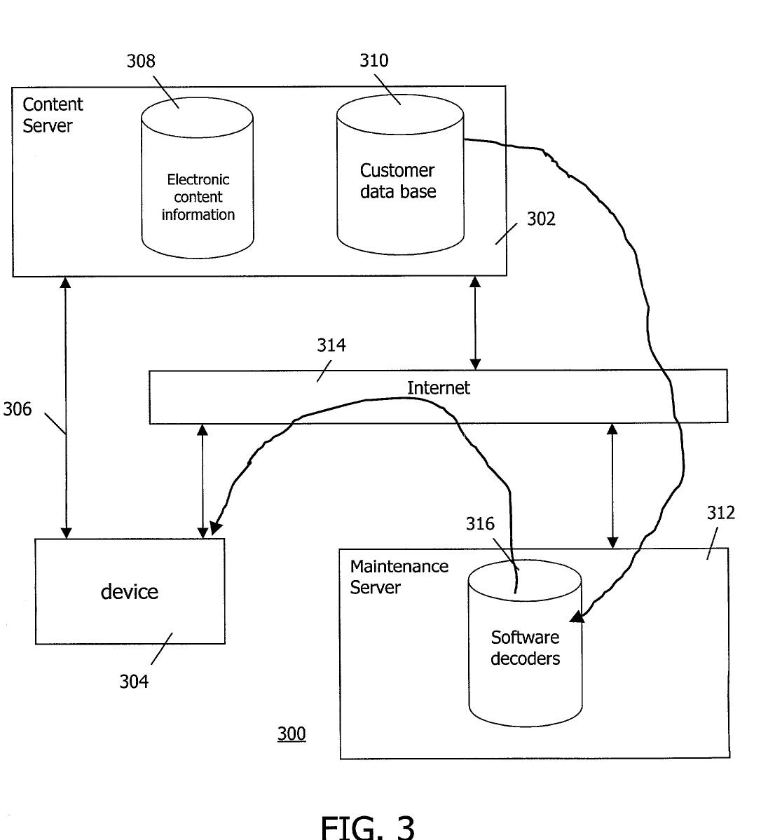

FIG. 3 is a block diagram of a system 300 in the invention. System 300 comprises a content server 302 of the content provider 170 accessible to an appliance 304 via a cable 306. Appliance 304 comprises a set top box (STB), in this example.

Server 302 has a library 308 of digital content information, e.g., music files of video files, live programs from broadcast stations, etc. The user 120 contacts the server 302 via his/her STB 304. Upon browsing the inventory 308, the user 120 makes a selection and requests the download or streaming of one or more specific content items or a certain broadcast program. The server 302 has a customer data base 310 for checking the history 180 of this particular user 120 as logged in the customer data base 310.

If the user 120 has not been registered in data base 310, the identifier of STB 304 is registered, preferably together with information about this user 120. The latter is supplied by the user him/herself in terms of a user profile upon registering with server 302, for example. Upon registering, the content gets downloaded or streamed to STB 304 via cable 306. Data base 310 also logs the information about which content has been selected by, and downloaded/streamed to, this user 120 and which software decoders the user has available at STB 304 for use with the content.

If this user 120 has already got an entry in the data base 310, the server 302 verifies if the user 120 has been logged with requests for the same or a similar content file. If the logged user's requests indicate that he/she requested and received the same or similar content information from the server 302 in the past, and that the user 120 has available the necessary decoding software for this content information, only the content is supplied.

If the data base 310 shows that the registered user does not have available the proper software for decoding the specific content information requested, a maintenance server 312 gets contacted, preferably automatically via the Internet 314. The server 312 has a database 316 of software elements for operational use on the set top box 304 depending on, e.g., the content to be processed or the services supplied by the cable provider's server 302. Server 312 sends the proper software to the set top box 304 via the Internet 314, so that the content can get downloaded or streamed to the user 120.

In a business model according to the invention the supplier of the content gets charged a fee per download of the decoder or plug-in or their upgrade so as to maintain STB 302 future-proof Both customer data base 310 and server 312 keep track of the number of downloads of the decoder or plug-in or their upgrade that have been induced by an end-user selecting the content information hosted by content server 302. The invention enables a business model for supplying software decoders and plug-ins and their upgrades. The availability of the content information and the user not being charged for the decoder or plug-in or their upgrade attract customers and generate traffic via the web site. The download of the decoder or plug-in or their upgrade can be administered for a specific type of encoded content information or encoding format or to a specific piece of content information.

Note that in this model the maintenance server has access to the customer data base 310 in order to carry out the maintenance service. This knowledge of the customer-related information can leverage services from the owner of maintenance server 312. For example, instead of or in addition to, the flat fee per decoder or upgrade download the maintenance service contract with the cable provider may stipulate that the maintenance service provider gets assigned a portion of the real estate of the Set top box's portal.

Reference is also made to the following documents which are incorporated herein by reference:

U.S. Ser. No. 09/345,339 (attorney PHA 23,700) filed Jul. 1, 1999 for Mark Hoffberg et al., for CONTENT-DRIVEN SPEECH- OR AUDIO-BROWSER, herein incorporated by reference. This document relates to categorizing resources on the Internet. The Internet is searched in order to find resources that provide audio such as live Internet broadcasts that can be streamed. The resources are identified based on their file extension and are categorized according to, e.g., the natural language or music style. The user is enabled to browse the collection based on textual or musical input.

U.S. Ser. No. 09/283,545 (attorney docket PHA 23,633) filed Apr. 1, 1999 for Eugene Shteyn for TIME- AND LOCATION-DRIVEN PERSONALIZED TV, herein incorporated by reference. This document discusses a server system that enables a subscriber to select a specific broadcast program for recording and a specific location and time frame for play-out of the recorded program.

U.S. Ser. No. 09/519,546 (attorney docket PH-US 000014) filed Mar. 6, 2000 for Erik Ekkel et al., for PERSONALIZING CE EQUIPMENT CONFIGURATION AT SERVER VIA WEB-ENABLED DEVICE. This document relates to the configuring of CE equipment by the consumer. The setting up of the configuration is facilitated by means of delegating the configuring to an application server on the Internet. The consumer enters his/her preferences in a specific interactive Web page through a suitable user-interface of an Internet-enabled device, such as a PC or set-top box or digital cellphone. The application server generates the control data based on the preferences entered and downloads the control data to the CE equipment itself or to the Internet-enabled device.

U.S. Ser. No. 09/160,490 (attorney docket PHA 23,500) filed Sep. 25, 1998 for Adrian Turner et al., for CUSTOMIZED UPGRADING OF INTERNET-ENABLED DEVICES BASED ON USER-PROFILE, herein incorporated by reference. This document discusses a server system that maintains a user profile of a particular end-user of consumer electronics network-enabled equipment and a data base of new technical features for this type of equipment. If there is a match between the user-profile and a new technical feature, and the user indicates to receive information about updates or sales offers, the user gets notified via the network of the option to obtain the feature.

U.S. Ser. No. 09/568,932 (attorney docket US 000106) filed May 11, 2000 for Eugene Shteyn and Ruud Roth for ELECTRONIC CONTENT GUIDE RENDERS CONTENT RESOURCES TRANSPARENT. This document relates to a data management system on a home network that collects data that is descriptive of content information available at various resources on the network. The data is combined in a single menu to enable the user to select from the content, regardless of the resource.

U.S. Ser. No. 09/189,535 (attorney docket PHA 23,527) filed Nov. 10, 1998 for Eugene Shteyn for UPGRADING OF SYNERGETIC ASPECTS OF HOME NETWORKS. This document relates to a server that has access to an inventory of devices and capabilities on a user's home network. The inventory is, for example, a look-up service as provided by HAVi or Jini architecture. The server has also access to a data base with information of features for a network. The server determines if the synergy of the apparatus present on the user's network can be enhanced based on the listing of the inventory and on the user's profile. If there are features that are relevant to the synergy, based on these criteria, the user gets notified.

U.S. Ser. No. 09/349,676 (attorney docket PHA 23,681) filed Jul. 8, 1999 for Kristen Ondeck for AFTER-SALES CUSTOMIZATION SPECIFIED BY RETAILER ACTS AS INCENTIVE. This document relates to a method of doing business that enables to stimulate commercial activities. A customer notifies a manufacturer or a dedicated service provider, of the purchase of merchandise from a specific retailer. Upon being notified, the manufacturer or service provider customizes a portal or home page for the customer by temporarily adding an advertisement banner associated with the retailer.

U.S. Pat. No. 6,047,128 relating to a system for replacing old software resident on an apparatus by new software via e.g., the Internet. The system has a control circuit and a storage device for storing the software. The system has a loading device for delivering the new software to the storage device. The control circuit stores the new software in the storage device after reception of an appropriate instruction. The new software comprises system software, at least consisting of operating software and downloading software. The new software also comprises new application software for controlling a component coupled to the module. During operational use of the component a first part of the storage device stores the new system software and a second part of the storage device stores the new application software. During the downloading of the new system software the control circuit erases the first part of the storage device, after the storage of the new system software in the second part of the storage device. The control circuit transfers subsequently the new system software from the second part to the first part of the storage device.

U.S. Ser. No. 09/521,051 (attorney docket US 000052) filed Mar. 8, 2000 for Geert Bruynsteen for BUSINESS MODEL FOR LEASING STORAGE SPACE ON A DIGITAL RECORDER. This document relates to adjusting the available amount of storage space of a fixed HDD on a CE device via a data network. The consumer can upgrade the device via a third party service that remotely controls the settings of the hard-disk drive.

U.S. Ser. No. 09/653,784 (attorney docket US 000220) filed Sep. 1, 2000 for Franciscus Caris, Frederik Ekkel and Thomas Dubil for STB CONNECTS REMOTE TO WEB SITE FOR CUSTOMIZED CODE DOWNLOADS. This document relates to a set top box that is marketed together with a programmable remote. The remote has a dedicated button to connect the set top box to a specific server on the Internet. The consumer can notify the server of his/her other CE equipment, which he/she desires to be controllable through the same remote as the one that came with the set top box. The server downloads to the set top box data representative of the relevant control codes. The set top box is provided with means to program the remote with these codes. In return the server has obtained detailed and accurate information about this consumer's equipment. A reliable customer base can thus be built for streamlining Help Desk operations.

What is claimed is:

1. A method of being compensated for a transfer of a software element to render a content information, the method comprising financially charging a content provider of the content information based on the transfer of the software element being triggered by an individual's request for the content information.

2. The method of claim 1, wherein the individual's request for the content information triggers the transfer of the software element based on a transfer history representative of other content information previously transferred to the individual.

3. The method of claim 1, wherein the content provider transfers the software element.

4. The method of claim 1, further comprising:
transferring the software element to the individual.

5. The method of claim 1, further comprising:
transferring a tag with the software element, the tag enabling a disablement of the software element.

6. The method of claim 5, wherein the tag is a counter.

7. The method of claim 5, wherein the disablement is automatic after a period of time.

8. The method of claim 5, wherein the disablement is automatic after the software element is used to render a specific number of content information.

9. A method of providing a content information, the method comprising:
advertising a content information;
causing an individual's request for the content information to selectively trigger a transfer of a software element to render the content information; and
financially compensating a provider of the software element based on the transfer of the software element.

10. The method of claim 9, wherein the content information is advertised on an electronic program guide.

11. The method of claim 9, wherein a data service provider provides the content information to a device over a data network and the software provider is an original equipment manufacturer of the device.

12. The method of claim 9, wherein the content information is advertised on a web-page.

13. The method of claim 9, further comprising:
charging a fee to the individual for a transfer of the information content.

14. The method of claim 9, further comprising:
charging a fee to the individual for the transfer of the software element.

15. The method of claim 9, further comprising:
advertising the transfer of the software element.

16. The method of claim 9, further comprising:
enabling the software provider to transfer the software element to the individual.

17. The method of claim 9, further comprising:
transferring the software element.

18. The method of claim 9, further comprising:
concealing the causing and the compensating to the individual.

19. The method of claim 9, wherein the software element comprises a decoder.

20. The method of claim 9, wherein the individual's request for the content information triggers the transfer of the software element based on a transfer history representative of data previously to the individual.

21. The method of claim 20, wherein the previously transferred data comprises another content information previously transferred to the individual.

22. The method of claim 20, wherein the previously transferred data comprises at least one software element previously transferred to the individual.
